(19) United States
(12) Patent Application Publication
(10) Pub. No.: US 2024/0160926 A1
(43) Pub. Date: May 16, 2024

(54) TEST-TIME ADAPTATION VIA SELF-DISTILLED REGULARIZATION

(71) Applicant: QUALCOMM Incorporated, San Diego, CA (US)

(72) Inventors: Junha SONG, Daejeon (KR); Sungha CHOI, Goyang-si (KR)

(21) Appl. No.: 18/479,723

(22) Filed: Oct. 2, 2023

Related U.S. Application Data
(60) Provisional application No. 63/424,315, filed on Nov. 10, 2022.

(51) Int. Cl. G06N 3/08; G06N 3/045

(52) U.S. Cl. CPC G06N 3/08; G06N 3/045

(57) ABSTRACT

A computer-implemented method includes adding an auxiliary network of a group of auxiliary networks to a respective partition of a group of partitions associated with a main network. The method also includes training each of the group of auxiliary networks with training data to adapt to a test distribution. The method further includes adapting each of the group of auxiliary networks with test data to adapt to the test distribution. The method still further includes classifying an input received at a model based on adapting each of the group of auxiliary networks. The model may include the group of partitions and the group of auxiliary networks.

### CROSS-REFERENCE TO RELATED APPLICATION

The present application claims the benefit of U.S. Provisional Patent Application No. 63/424,315, filed on Nov. 10, 2022, and titled “TEST-TIME ADAPTATION VIA SELF-DISTILLED REGULARIZATION,” the disclosure of which is expressly incorporated by reference in its entirety.

### FIELD OF THE DISCLOSURE

Aspects of the present disclosure generally relate to test-time adaptation of an artificial neural network via self-distilled regularization.

### BACKGROUND

Artificial neural networks may comprise interconnected groups of artificial neurons (e.g., neuron models). The artificial neural network may be a computational device or be represented as a method to be performed by a computational device. Convolutional neural networks are a type of feed-forward artificial neural network. Convolutional neural networks may include collections of neurons that each have a receptive field and that collectively tile an input space. Convolutional neural networks (CNNs), such as deep convolutional neural networks (DCNs), have numerous applications. In particular, these neural network architectures are used in various technologies, such as image recognition, speech recognition, acoustic scene classification, keyword spotting, autonomous driving, and other classification tasks.

A discrepancy between a source domain and a target domain may degrade performance of a deep learning model. In some cases, time test adaptation (TTA) may be specified to address such domain shifts. In TTA, a pre-trained model adapts to the target domain in an online manner without access to source data and/or target labels. Although conventional TTA implementations improve the performance of the deep learning model when faced with the discrepancy between the source domain and the target domain, such conventional TTA implementations increase resource use (e.g., memory use and/or processor use) of a device that implements the deep learning model.

Additionally, some conventional TTA methods assume a fixed target domain. Still, in the real world, the target domain may continually change (e.g., continuously changing driving environments for autonomous vehicles). Therefore, some conventional TTA methods attempt to adapt to continuously changing environments. However, these conventional TTA methods face various challenges when adapting to continuously changing environments. These challenges include, for example, but are not limited to, catastrophic forgetting and error accumulation.

### SUMMARY

In some aspects, a computer-implemented method includes adding a respective auxiliary network of a group of auxiliary networks to each partition of a group of partitions associated with a main network. The method also includes training each of the group of auxiliary networks with training data to adapt to a test distribution. The method further includes adapting each of the group of auxiliary networks with test data to adapt to the test distribution. The method still further includes classifying an input received at a model based on adapting each of the group of auxiliary networks. The model includes the main network and the group of auxiliary networks.

Some other aspects of the present disclosure are directed to an apparatus including means for adding a respective auxiliary network of a group of auxiliary networks to each partition of a group of partitions associated with a main network. The apparatus also includes means for training each of the group of auxiliary networks with training data to adapt to a test distribution. The apparatus further includes means for adapting each of the group of auxiliary networks with test data to adapt to the test distribution. The apparatus still further includes means for classifying an input received at a model based on adapting each of the group of auxiliary networks. The model includes the main network and the group of auxiliary networks.

In some other aspects of the present disclosure, a non-transitory computer-readable medium with non-transitory program code recorded thereon is disclosed. The program code is executed by one or more processors and includes program code to add a respective auxiliary network of a group of auxiliary networks to each partition of a group of partitions associated with a main network. The program code also includes program code to train each of the group of auxiliary networks with training data to adapt to a test distribution. The program code further includes program code to adapt each of the group of auxiliary networks with test data to adapt to the test distribution. The program code still further includes program code to classify an input received at a model based on adapting each of the group of auxiliary networks. The model includes the main network and the group of auxiliary networks.

Some other aspects of the present disclosure are directed to an apparatus having one or more processors, and one or more memories coupled with the one or more processors and storing instructions operable, when executed by the one or more processors, to cause the apparatus to add a respective auxiliary network of a group of auxiliary networks to each partition of a group of partitions associated with a main network. Execution of the instructions also cause the apparatus to train each of the group of auxiliary networks with training data to adapt to a test distribution. Execution of the instructions further cause the apparatus to adapt each of the group of auxiliary networks with test data to adapt to the test distribution. Execution of the instructions still further cause the apparatus to classify an input received at a model based on adapting each of the group of auxiliary networks. The model includes the main network and the group of auxiliary networks.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with various aspects of the present disclosure.

FIG. 2D is a diagram illustrating an exemplary deep convolutional network (DCN), in accordance with various aspects of the present disclosure.

FIG. 3 is a block diagram illustrating an exemplary DCN, in accordance with various aspects of the present disclosure.

FIG. 4 is a block diagram illustrating an example of a time test adaptation (TTA) architecture, in accordance with various aspects of the present disclosure.

FIG. 5 is a block diagram illustrating an example of a TTA architecture for a main network model, in accordance with various aspects of the present disclosure.

FIG. 6 is a flow diagram illustrating an example process performed, for example, by a neural network, in accordance with various aspects of the present disclosure.

### DETAILED DESCRIPTION

The detailed description set forth below and in Appendices A and B in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

As discussed, a discrepancy between a source domain and a target domain may degrade performance of a deep learning model. In some cases, time test adaptation (TTA) may be specified to address such domain shifts. In TTA, a pre-trained model adapts to the target domain in an online manner without access to source data and/or target labels. Although conventional TTA methods improve the performance of the deep learning model when faced with the discrepancy between the source domain and the target domain, such conventional TTA methods increase resource use (e.g., memory use and/or processor use) of a device that implements the deep learning model. It may be desirable to improve TTA methods to reduce resource use (e.g., memory use and/or processor use) of the device that implements the deep learning model.

Some conventional TTA models update entire model parameters to improve model performance. Still, updating entire model parameters may be impractical when an available amount of on-device memory (e.g., SRAM, DRAM, and/or tightly coupled memory (TCM)) is limited. To address such an issue, several TTA approaches only update batch normalization (BN) parameters to promote both TTA performance and memory efficiency. However, updating BN parameters may not adequately improve memory use (e.g., reduce memory use) because a specified amount of memory may be dependent on a size of intermediate activations specified for gradient calculations, rather than the learnable parameters such as BN parameters.

Additionally, some conventional TTA methods assume a fixed target domain. Still, in the real world, the target domain may continually change (e.g., continuously changing driving environments for autonomous vehicles). Therefore, some conventional TTA methods attempt to adapt to continuously changing environments. However, these conventional TTA methods face various challenges, when adapting to continuously changing environments. These challenges include, for example, catastrophic forgetting and error accumulation. Catastrophic forgetting refers to degraded performance on the source domain due to adaptation to target domains. In conventional TTA methods, such failures may be frequently observed in long term adaptation. In the real world, the test samples may be obtained from both the source domain and the target domain. Training a model with unsupervised loss may cause error accumulation. In some cases, error accumulation in TTA may be aggravated with continuous TTA because continuous TTA may be performed for a long period of time.

Various aspects of the present disclosure are directed to efficiently adapting a deep learning model, via TTA, in a constantly changing environment. Such aspects are more specifically directed to a TTA method that improves memory use and mitigates catastrophic forgetting and error accumulation. In some examples, a memory-efficient architecture may include a fixed (e.g., frozen) main network and a lightweight auxiliary network. The main network may be fixed after initial training to discard intermediate activations that occupy a large amount of memory. In such examples, a lightweight auxiliary network may include a single BN layer and a convolutional layer to adapt to the target domain. Additionally, in some examples, a self-distilled regularization method may be specified in order to mitigate catastrophic forgetting and error accumulation. In such examples, features of the auxiliary model may be constrained to prevent significant deviation from features extracted by the fixed main network. This regularization addresses catastrophic forgetting and error accumulation because a pre-trained model (e.g., fixed main network) maintains the knowledge on the source domain.

Particular aspects of the subject matter described in this disclosure can be implemented to realize one or more of the following potential advantages. In some examples, the described techniques, such as establishing a fixed main network and an auxiliary network, may improve memory use while also mitigating catastrophic forgetting and error accumulation.

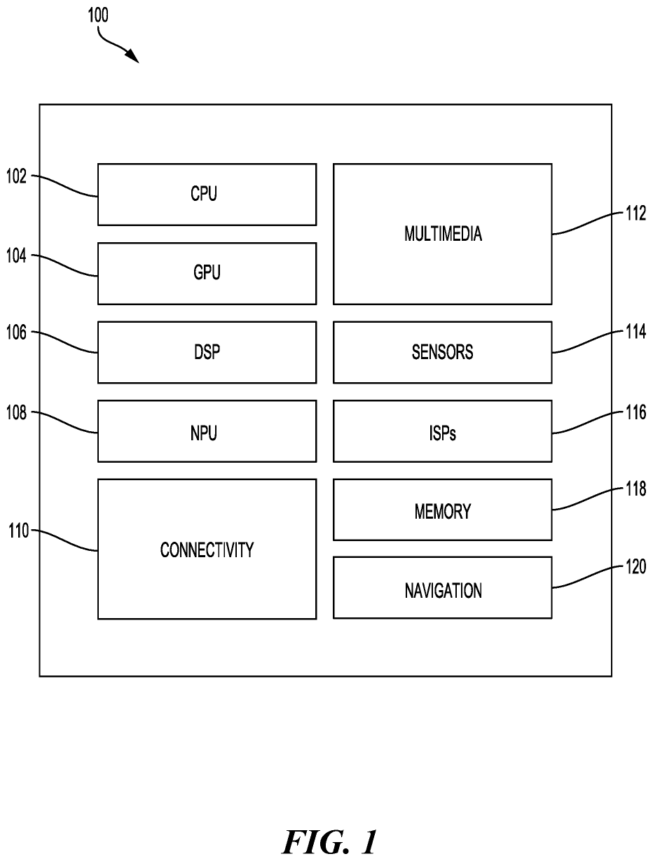

FIG. 1 illustrates an example implementation of a system-on-a-chip (SOC) 100, which may include a central processing unit (CPU) 102 or a multi-core CPU configured for TTA. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the general-purpose processor 102 may include code to: receive, at a pose estimation model, image data comprising a plurality of two-dimensional (2D) images of an object, each 2D image of the plurality of 2D images representing a different pose of the object; and estimate, via the pose estimation model, a respective pose of each 2D image from two or more of the plurality of 2D images based on a similarity metric between two or more pairs of 2D images of the plurality of 2D images.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

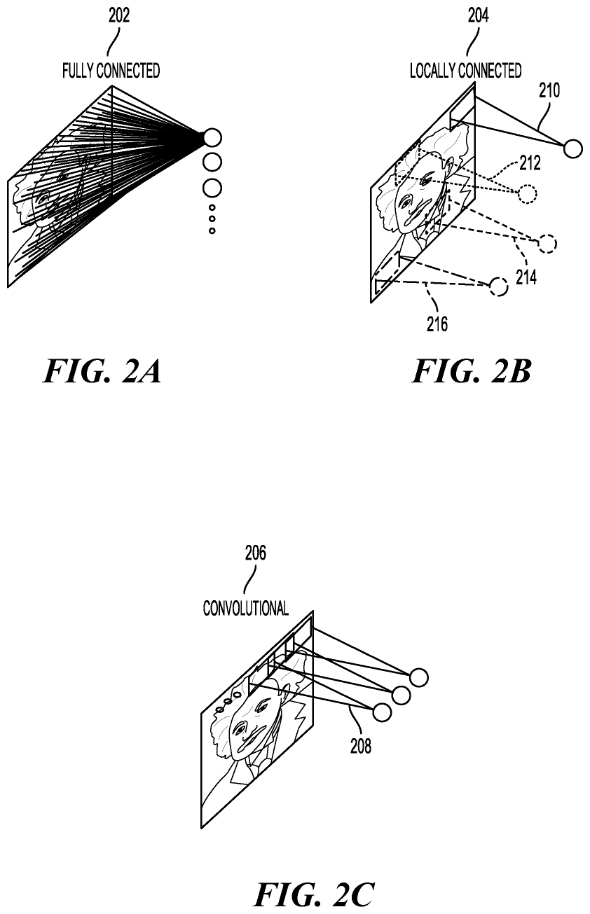

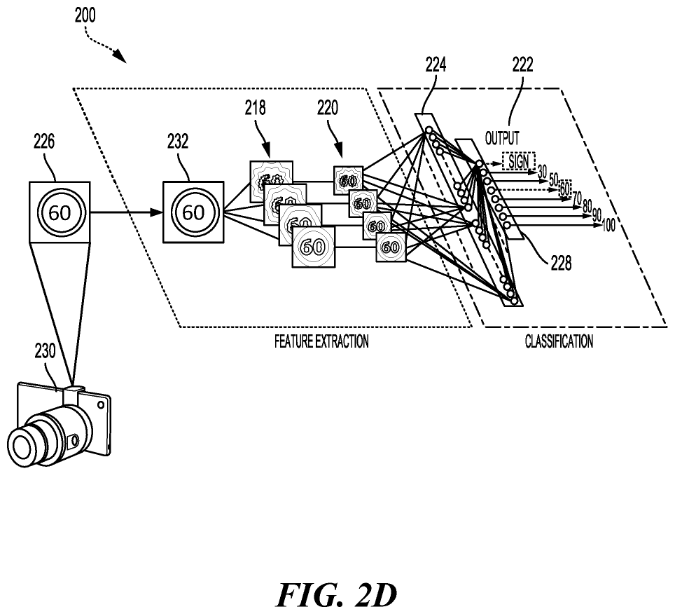

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images (e.g., the speed limit sign of the image 226) and a forward pass through the network may yield an output 222 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

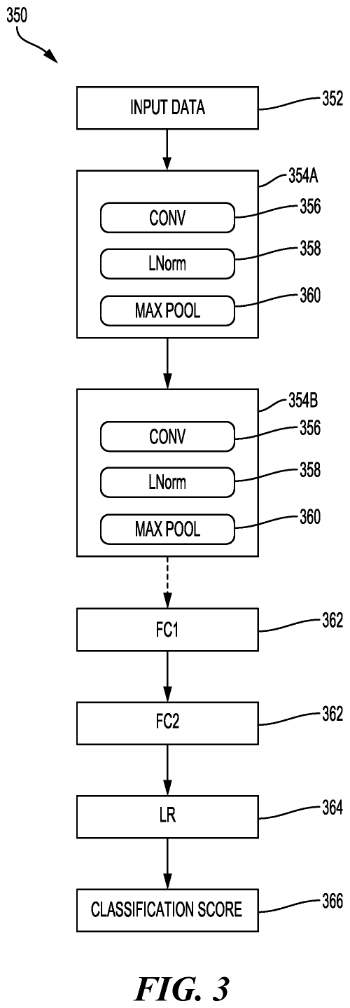

FIG. 3 is a block diagram illustrating a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

The convolution layers 356 may include one or more convolutional filters, which may be applied to the input data to generate a feature map. Although only two of the convolution blocks 354A, 354B are shown, the present disclosure is not so limiting, and instead, any number of the convolution blocks 354A, 354B may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 to achieve high performance and low power consumption. In alternative embodiments, the parallel filter banks may be loaded on the DSP 106 or an ISP 116 of an SOC 100. In addition, the deep convolutional network 350 may access other processing blocks that may be present on the SOC 100, such as sensor processor 114 and navigation module 120, dedicated, respectively, to sensors and navigation.

The deep convolutional network 350 may also include one or more fully connected layers 362 (FC1 and FC2). The deep convolutional network 350 may further include a logistic regression (LR) layer 364. Between each layer 356, 358, 360, 362, 364 of the deep convolutional network 350 are weights (not shown) that are to be updated. The output of each of the layers (e.g., 356, 358, 360, 362, 364) may serve as an input of a succeeding one of the layers (e.g., 356, 358, 360, 362, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data, including a feature from a set of features.

As discussed, a discrepancy between a source domain and a target domain may degrade performance of a deep learning model. In some cases, time test adaptation (TTA) may be specified to address such domain shifts. In TTA, a pre-trained model adapts to the target domain in an online manner without access to source data and/or target labels. Although conventional TTA methods improve the performance of the deep learning model when faced with the discrepancy between the source domain and the target domain, such conventional TTA methods increase resource use (e.g., memory use and/or processor use) of a device that implements the deep learning model. It may be desirable to improve TTA methods to reduce resource use (e.g., memory use and/or processor use) of the device that implements the deep learning model.

Some conventional TTA methods update entire model parameters to improve model performance. Still, updating entire model parameters may be impractical when an available amount of on-device memory (e.g., SRAM, DRAM, and/or TCM) is limited. To address such an issue, several TTA approaches only update batch normalization (BN) parameters to promote both TTA performance and memory efficiency. However, updating BN parameters may not adequately improve memory use (e.g., reduce memory use) because a specified amount of memory may be dependent on a size of intermediate activations specified for gradient calculations, rather than the learnable parameters such as BN parameters.

Additionally, some conventional TTA methods assume a fixed target domain. Still, in the real world, the target domain may continually change (e.g., continuously changing driving environments for autonomous vehicles). Therefore, some conventional TTA methods attempt to adapt to continuously changing environments. However, these conventional TTA methods face various challenges, when adapting to continuously changing environments. These challenges include, for example, catastrophic forgetting and error accumulation. Catastrophic forgetting refers to degraded performance on the source domain due to adaptation to target domains. In conventional TTA methods, such failures may be frequently observed in long term adaptation. In the real world, the test samples may be obtained from both the source domain and the target domain.

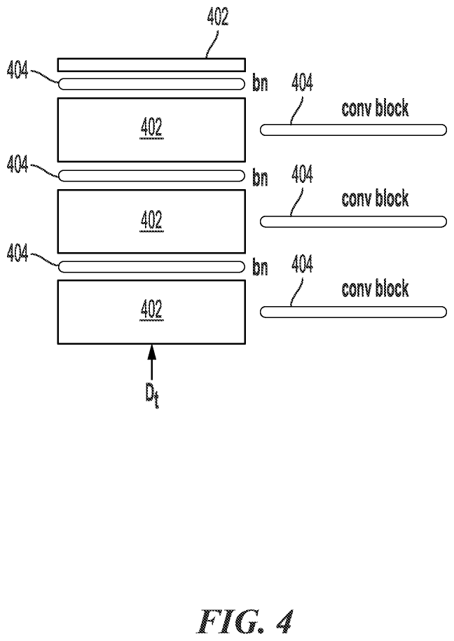

Various aspects of the present disclosure are directed to efficiently adapting a deep learning model, via TTA, in a constantly changing environment. Such aspects are more specifically directed to a TTA method that improves memory use and mitigates catastrophic forgetting and error accumulation. FIG. 4 is a block diagram illustrating an example of a TTA architecture 400, in accordance with various aspects of the present disclosure. The TTA architecture 400 may be implemented via an SOC, such as the SOC 100 described with reference to FIG. 1. In some examples, a TTA architecture 400 may include a fixed (e.g., frozen) main network 402 and an auxiliary network 404. The auxiliary network 404 may be an example of a lightweight network. As shown in the example of FIG. 4, the main network 402 may be partitioned into multiple parts. Each part of the main network 402 may be associated with an auxiliary network 404.

In some examples, the main network 402 may be fixed after initial training to discard intermediate activations that occupy a large amount of memory. In such examples, each auxiliary network 404 may include a single batch normalization (BN) layer and a convolutional layer (shown as “conv block” in FIG. 4) to adapt to the target domain. Additionally, in some examples, self-distilled regularization may be specified to mitigate catastrophic forgetting and error accumulation. In such examples, features of each auxiliary network 404 may be constrained to prevent significant deviation from features extracted by the fixed main network. This regularization addresses catastrophic forgetting and error accumulation because a pre-trained model (e.g., fixed main network 402) maintains the knowledge on the source dataset [symbol] ₛ. After the TTA architecture 400 is deployed, the auxiliary networks 404 may be updated via unsupervised loss (e.g., entropy minimization) on a target dataset [symbol] ₜ, while the main network 402 is not updated, such that the main network 402 remains fixed.

In some examples, a forward process and a corresponding backpropagation may be formulated. In various aspects of the present disclosure, activations refer to intermediate features stored during the forward process, which are used for gradient calculations during backpropagation. In some implementations, an i^{th} linear layer in a network includes weight [symbol] and bias b. The input and output of such layers are ƒᵢ and ƒᵢ₊₁, respectively. Given a forward process of ƒᵢ₊₁=ƒᵢ [symbol] +b, the backpropagation with the loss [symbol] and [symbol] is formulated as:

$$\frac{\partial ℒ}{\partial {f}_{i}} = \frac{\partial ℒ}{\partial {f}_{i + 1}} {𝒲}^{T} , \frac{\partial ℒ}{\partial 𝒲} = {f}_{i}^{T} \frac{\partial ℒ}{\partial {f}_{i + 1}} \qquad ( 1 )$$

In some examples, an encoder of an agnostic pre-trained model (e.g., main network) is segmented into K parts, which may be referred to as a model partition factor K. In such examples, an auxiliary network may be associated with (e.g., attached to) each part K. One group of auxiliary networks is composed of one convolution layer, one batch normalization layer, and one rectified linear unit (Conv-BN-ReLu). Each auxiliary network may be preliminary trained using a source dataset [symbol] ₛ before deployment. The source dataset [symbol] ₛ is not used during test time. After the pre-trained model is deployed, the auxiliary networks may be updated via unsupervised loss (e.g., entropy minimization) on target dataset [symbol] ₜ, while the original networks are frozen (e.g., not updated). In some examples, when partitioning the encoder of the pre-trained model into K parts, such as, for example, four or five parts, shallow parts of the encoder may be densely partitioned in comparison to deep parts of the encoder. Aspects of the present disclosure are not limited to partitioning the encode into four or five parts.

An inherent risk with extended adaptation is the build-up of errors and the risk of catastrophic forgetting. To mitigate the build-up of errors and the risk of catastrophic forgetting, a regularization technique may be used to align an output \tilde{x}ₖ of each group within the auxiliary networks with an output xₖ from the original network. Within this context, a parameter x represents features originating from the foundational networks, while a parameter \tilde{x} represents features modified by the auxiliary networks.

Upon deployment and during test-time adaptation, only the auxiliary networks are adjusted to suit test domains, while the main network remains static. In some examples, entropy minimization may be applied to the samples achieving entropy less than a pre-defined entropy threshold H₀. The entropy minimization may be represented as H(ŷ)=−Σ_{c}p(ŷ)log p(ŷ), where a parameter ŷ represents a prediction output of a test image from test dataset [symbol] ₜ and p( ) represents a softmax function. A primary loss function [symbol] ^{ent} for adaptation is defined as:

[symbol]

^{ent}= [symbol] _{{H(ŷ)<H}_{₀}_{}}·H(ŷ), (2)

where [symbol] _{{·}} is an indicator function. In some examples, a proposed regularization [symbol] ^{k} may be applied. A total (e.g., cumulative) loss [symbol] _{θ}^{total} may be expressed as:

[symbol]

_{θ}^{total}= [symbol] _{θ}^{ent}+λΣₖ^{K} [symbol] _{θ}_{ₖ}^{k}, (3)

where parameters θ and θₖ denote parameters of all auxiliary networks and a k-th group of auxiliary networks, respectively, and a hyperparameter λ may balance a scale of the two loss functions ( [symbol] _{θ}^{total} and [symbol] _{θ}^{ent}).

A model associated with various aspects of the present disclosure may use less memory than conventional systems because the main network is not updated after pre-training. Additionally, intermediate activations may be discarded.

In some cases, the unsupervised loss from unlabeled test data [symbol] ₜ may introduce one or more false signals (e.g., noise) to the model. The false signals may be represented as ŷ≠yₜ, where the parameter yₜ represents a ground truth test label. As discussed, long term adaptation with unsupervised loss may cause model collapse due to error accumulation and catastrophic forgetting. In some examples, a distilled regularization may be used to prevent model collapse due to error accumulation and catastrophic forgetting. In such examples, the output \tilde{x}ₖ of each k-th group of the auxiliary networks may be regularized, such that the output \tilde{x}ₖ does not deviate from the output xₖ of the k-th part of frozen main networks. A regularization loss that computes the mean absolute error (e.g., L1 loss) may be as follows:

[symbol]

_{θ}_{ₖ}^{k}=∥\tilde{x}ₖ−xₖ∥₁. (4)

Because the main networks are not updated, the main networks embed features x_{k,k˜K}, which contains knowledge learned from a source domain. In some examples, the output \tilde{x}ₖ of the auxiliary networks may be regularized with knowledge distilled from the original networks.

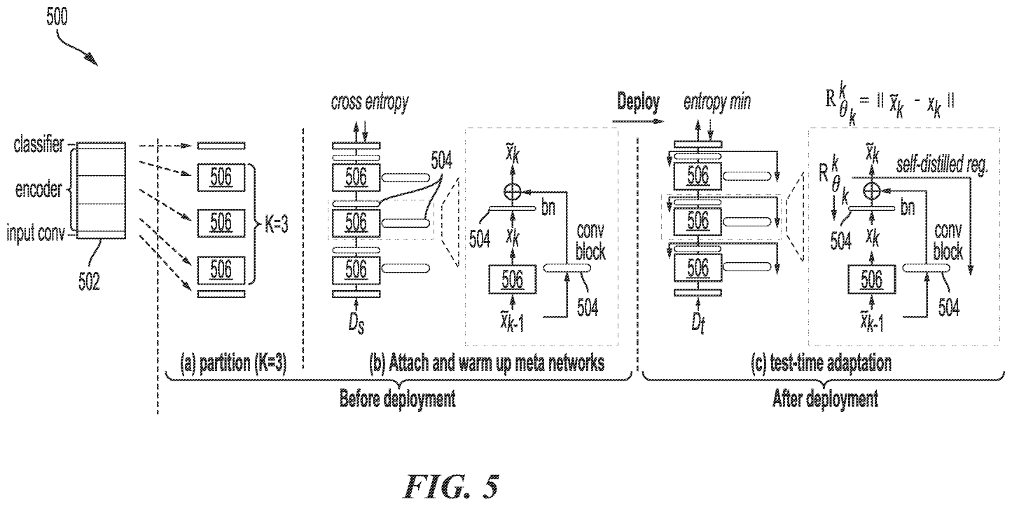

FIG. 5 is a block diagram illustrating an example of a TTA architecture 500 for a main network model 502, in accordance with various aspects of the present disclosure. In some examples, the TTA architecture 500 may be implemented via an SOC, such as the SOC 100 described with reference to FIG. 1. The TTA architecture 500 facilitates TTA on memory-constrained devices, such as edge devices, and may reduce error accumulation that may occur during unsupervised learning over time. In the example of FIG. 5, for ease of explanation, the main network model 502 may also be referred to as the main network 502. The main network 502 may include, but is not limited to, a classifier layer, one or more encoder layers, and an input convolutional layer. In some examples, the main network 502 may be an example of a pre-trained agnostic model that is pre-trained on a source dataset [symbol] ₛ (e.g., a source domain) via any training method, such as supervised or un-supervised learning. The main network 502 may fixed (e.g., frozen) after the pre-training. That is, parameters of the main network 502 may not be updated or modified after the pre-training. During the pre-training stage, parameters of the main network 502 may be updated via gradient descent to minimize a cross-entropy (CE) loss.

As shown in FIG. 5, the main network 502 may be partitioned into a group of partitions 506. In some examples, each partition 506 corresponds to a layer of the main network 502. In some such examples, the one or more encoder layers may be partitioned based on a model partition factor K. In the example of FIG. 5, the model partition factor K, such that three partitions 506 are associated with the one or more encoder layers. Each of the K partitions 506 may be associated with a respective auxiliary network 504 from a group of auxiliary networks. Each auxiliary network 504 includes a batch normalization (BN) layer and one convolution block (shown as “conv block” in FIG. 5). For ease of explanation, only one auxiliary network 504 is labeled in FIG. 5. The convolution block may include a convolutional layer, a batch normalization layer, and a rectified linear unit (ReLU). The batch normalization layer associated with the convolution block may be distinct from the other batch normalization layer associated with the auxiliary network 504. Before deployment, each auxiliary network 504 may be trained on the source dataset [symbol] ₛ. Parameters of each auxiliary network 504 may be updated using cross-entropy loss for the small epoch, such that the group of auxiliary networks may adapt to a test distribution once deployed. In some examples, each auxiliary network 504 includes one or more layers and is optimized during testing. Therefore, the TTA architecture 500 of FIG. 5 may use less memory in comparison to conventional TTA architectures. In some examples, adaptability in a domain shift may be improved based on lower layers of the main network 502 being densely partitioned when the main network 502 is divided into the partitions 506.

As shown in the example of FIG. 5, the K-th partition 506 and a convolution block of the K-th auxiliary network 504 may receive an output \tilde{x}ₖ₋₁ of a prior layer. The K-th partition 506 generates an output xₖ that is received at a batch normalization layer of the K-th auxiliary network 504. An output \tilde{x}ₖ of the K-th auxiliary network 504 may be the sum of the output of the respective batch normalization layer and the respective convolution block.

In some examples, after deployment, each auxiliary network 504 may be updated on a target dataset [symbol] ₜ (e.g., test data) while being regularized with knowledge distilled from the main network 502. In such examples, after deployment, the partitions 506 may be fixed, however, the group of auxiliary networks may be adapted by minimizing an entropy loss (e.g., overall loss) during test time. Specifically, as discussed, entropy minimization may be applied to the samples achieving entropy less than a pre-defined entropy threshold H₀. The entropy minimization may be represented as H(ŷ)=−Σ_{c}p(ŷ)log p(ŷ). A loss, such as the total loss [symbol] _{θ}^{total} from unlabeled target data [symbol] ₜ may introduce one or more false signals (e.g., noise) to the model. As shown in the example of FIG. 5, the output \tilde{x}ₖ of the k-th auxiliary network 504 may be regularized, such that the output \tilde{x}ₖ does not deviate from the output xₖ of the k-th partition 506. A regularization loss [symbol] _{θ}_{ₖ}^{k} is described in EQUATION 4.

The regularization loss may determine a mean absolute error, such as an L1 loss, between the output xₖ of the k-th partition 506 and the output \tilde{x}ₖ of the k-th auxiliary network 504. Because the partitions 506 are not modified, the partitions 506 may embed features consistently using the knowledge learned from the source data. Therefore, the self-distilled knowledge from the partitions 506 may be used to regularize updates to each auxiliary network 504. The regularization may mitigate noise generated based on an unsupervised loss from training on unlabeled test data.

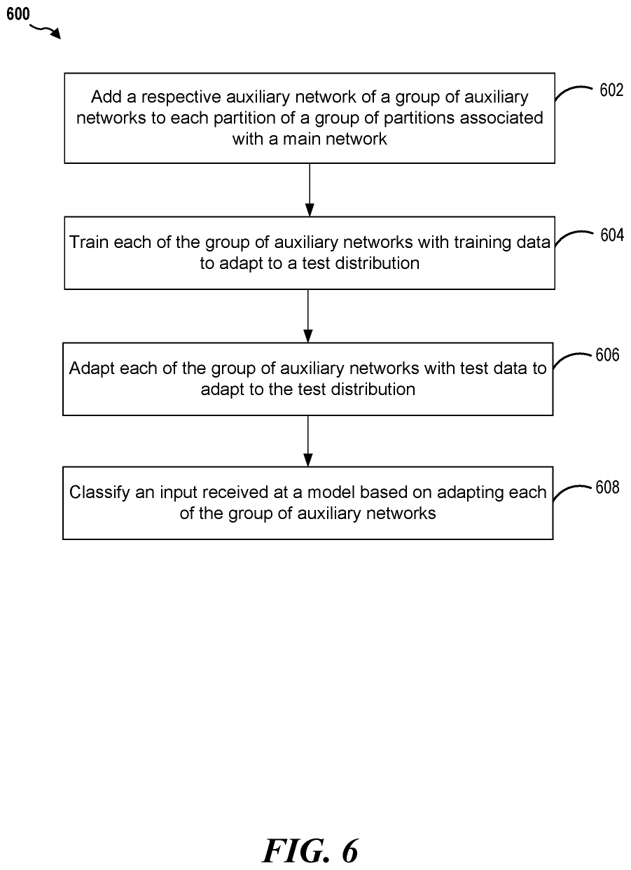

FIGURE is a flow diagram illustrating an example process 600 performed, for example, by a neural network, in accordance with various aspects of the present disclosure. The process 600 may be an example of a process for TTA. The process 600 may be performed by a TTA architecture, such as the TTA architecture 500 described with reference to FIG. 5, and/or a neural network, such as a neural network implemented via an SOC 100 as described with reference to FIG. 1. As shown in FIG. 6, the process 600 may begin at block 602 by adding a respective auxiliary network of a group of auxiliary networks to each partition of a group of partitions associated with a main network. At block 604, the process 600 trains each of the group of auxiliary networks with training data to adapt to a test distribution. At block 606, the process 600 adapts each of the group of auxiliary networks with test data to adapt to the test distribution. Finally, at block 608, the process 600 classifies an input received at a model based on adapting each of the group of auxiliary networks. The model may include the main network and the group of auxiliary networks.

Implementation examples are described in the following numbered clauses:
Clause 1. A computer-implemented method, comprising: adding a respective auxiliary network of a plurality of auxiliary networks to each partition of a plurality of partitions associated with a main network; training each of the plurality of auxiliary networks with training data to adapt to a test distribution; adapting each of the plurality of auxiliary networks with test data to adapt to the test distribution; and classifying an input received at a model based on adapting each of the plurality of auxiliary networks, the model including the main network and the plurality of auxiliary networks.
Clause 2. The computer-implemented method of Clause 1, further comprising: training the main network with the training data; and dividing the main network into the plurality of partitions.
Clause 3. The computer-implemented method of Clause 2, wherein the main network is fixed after training with the training data.
Clause 4. The computer-implemented method of any one of Clauses 1-2, wherein each of the plurality of auxiliary networks includes a first batch normalization layer and a convolution block.
Clause 5. The computer-implemented method of Clause 4, wherein the convolution block includes a convolution layer, a second batch normalization layer, and a rectified linear unit (ReLU).
Clause 6. The computer-implemented method of any one Clauses 1-5, wherein the training data is different than the test data.
Clause 7. The computer-implemented method of any one Clauses 1-5, further comprising: determining, for each auxiliary network of the plurality of auxiliary networks, a mean absolute error between a first output of the respective partition and a second output of the auxiliary network; and constraining the adapting of each auxiliary network of the plurality of auxiliary networks based on the mean absolute error.
Clause 8. An apparatus comprising a processor, memory coupled with the processor, and instructions stored in the memory and operable, when executed by the processor to cause the apparatus to perform any one of Clauses 1 through 7.
Clause 9. An apparatus comprising at least one means for performing any one of Clauses 1 through 7.
Clause 10. A computer program comprising code for causing an apparatus to perform any one of Clauses 1 through 7.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A computer-implemented method, comprising:
adding a respective auxiliary network of a plurality of auxiliary networks to each partition of a plurality of partitions associated with a main network;
training each of the plurality of auxiliary networks with training data to adapt to a test distribution;
adapting each of the plurality of auxiliary networks with test data to adapt to the test distribution; and
classifying an input received at a model based on adapting each of the plurality of auxiliary networks, the model including the main network and the plurality of auxiliary networks.

2. The computer-implemented method of claim 1, further comprising:
training the main network with the training data; and
dividing the main network into the plurality of partitions.

3. The computer-implemented method of claim 2, wherein the main network is fixed after training with the training data.

4. The computer-implemented method of claim 1, wherein each of the plurality of auxiliary networks includes a first batch normalization layer and a convolution block.

5. The computer-implemented method of claim 4, wherein the convolution block includes a convolution layer, a second batch normalization layer, and a rectified linear unit (ReLU).

6. The computer-implemented method of claim 1, wherein the training data is different than the test data.

7. The computer-implemented method of claim 1, further comprising:
determining, for each auxiliary network of the plurality of auxiliary networks, a mean absolute error between a first output of the respective partition and a second output of the auxiliary network; and
constraining the adapting of each auxiliary network of the plurality of auxiliary networks based on the mean absolute error.

8. An apparatus, comprising:
means for adding a respective auxiliary network of a plurality of auxiliary networks to each partition of a plurality of partitions associated with a main network;
means for training each of the plurality of auxiliary networks with training data to adapt to a test distribution;
means for adapting each of the plurality of auxiliary networks with test data to adapt to the test distribution; and
means for classifying an input received at a model based on adapting each of the plurality of auxiliary networks, the model including the main network and the plurality of auxiliary networks.

9. The apparatus of claim 8, further comprising:
means for training the main network with the training data; and
means for dividing the main network into the plurality of partitions.

10. The apparatus of claim 9, wherein the main network is fixed after training with the training data.

11. The apparatus of claim 8, wherein each of the plurality of auxiliary networks includes a first batch normalization layer and a convolution block.

12. The apparatus of claim 11, wherein the convolution block includes a convolution layer, a second batch normalization layer, and a rectified linear unit (ReLU).

13. The apparatus of claim 8, wherein the training data is different than the test data.

14. The apparatus of claim 8, further comprising:
means for determining, for each auxiliary network of the plurality of auxiliary networks, a mean absolute error between a first output of the respective partition and a second output of the auxiliary network; and
means for constraining the adapting of each auxiliary network of the plurality of auxiliary networks based on the mean absolute error.

15. An apparatus, comprising:
one or more processors; and
one or more memories coupled with the one or more processors and storing instructions operable, when executed by the one or more processors, to cause the apparatus to:
add a respective auxiliary network of a plurality of auxiliary networks to each partition of a plurality of partitions associated with a main network;
train each of the plurality of auxiliary networks with training data to adapt to a test distribution;
adapt each of the plurality of auxiliary networks with test data to adapt to the test distribution; and
classify an input received at a model based on adapting each of the plurality of auxiliary networks, the model including the main network and the plurality of auxiliary networks.

16. The apparatus of claim 15, wherein execution of the instructions further cause the apparatus to:
train the main network with the training data; and
divide the main network into the plurality of partitions.

17. The apparatus of claim 16, wherein the main network is fixed after training with the training data.

18. The apparatus of claim 15, wherein each of the plurality of auxiliary networks includes a first batch normalization layer and a convolution block.

19. The apparatus of claim 18, wherein the convolution block includes a convolution layer, a second batch normalization layer, and a rectified linear unit (ReLU).

20. The apparatus of claim 15, wherein the training data is different than the test data.

21. The apparatus of claim 15, wherein execution of the instructions further cause the apparatus to:
determine, for each auxiliary network of the plurality of auxiliary networks, a mean absolute error between a first output of the respective partition and a second output of the auxiliary network; and
constrain the adapting of each auxiliary network of the plurality of auxiliary networks based on the mean absolute error.

22. A non-transitory computer-readable medium having program code recorded thereon, the program code executed by one or more processors and comprising:
program code to add a respective auxiliary network of a plurality of auxiliary networks to each partition of a plurality of partitions associated with a main network;
program code to train each of the plurality of auxiliary networks with training data to adapt to a test distribution;
program code to adapt each of the plurality of auxiliary networks with test data to adapt to the test distribution; and
program code to classify an input received at a model based on adapting each of the plurality of auxiliary networks, the model including the main network and the plurality of auxiliary networks.

23. The non-transitory computer-readable medium of claim 22, wherein the program code further comprises:
program code to train the main network with the training data; and
program code to divide the main network into the plurality of partitions.

24. The non-transitory computer-readable medium of claim 23, wherein the main network is fixed after training with the training data.

25. The non-transitory computer-readable medium of claim 22, wherein each of the plurality of auxiliary networks includes a first batch normalization layer and a convolution block.

26. The non-transitory computer-readable medium of claim 25, wherein the convolution block includes a convolution layer, a second batch normalization layer, and a rectified linear unit (ReLU).

27. The non-transitory computer-readable medium of claim 22, wherein the training data is different than the test data.

28. The non-transitory computer-readable medium of claim 22, wherein the program code further comprises:
program code to determine, for each auxiliary network of the plurality of auxiliary networks, a mean absolute error between a first output of the respective partition and a second output of the auxiliary network; and
program code to constrain the adapting of each auxiliary network of the plurality of auxiliary networks based on the mean absolute error.
